(19) United States
(12) Patent Application Publication
(10) Pub. No.: US 2026/0252948 A1
(43) Pub. Date: Aug. 27, 2026

(54) SERVER-SIDE PROMPT-TUNING FOR MODEL CUSTOMIZATION

(71) Applicant: NVIDIA Corporation, Santa Clara, CA (US)

(72) Inventors: Ryan ANGILLY, Denver, CO (US); Jessica BUHL, Wilmette, IL (US); Hannah ZHANG, Sunnyvale, CA (US); Octavian DRULEA, Alameda, CA (US)

(73) Assignee: NVIDIA Corporation, Santa Clara, CA (US)

(21) Appl. No.: 19/060,084

(22) Filed: Feb. 21, 2025

(51) Int. Cl. G06N 20/00; G06F 11/34

(52) U.S. Cl. CPC G06N 20/00; G06F 11/3447

(57) ABSTRACT

In various examples, systems and methods are disclosed relating to a model customization pipeline. A system can receive prompts from a user identifying a model to use. The identified model can be deployed for use with customizations relative to a base model. The system can obtain the identified model and apply the prompt as input to the model to generate an output. The output can be provided for presentation to the user. The deployment of the model customization at the system can allow for more effective customization.

### BACKGROUND

Implementing prompt-tuned model customization and distribution in systems that process outputs (e.g., textual data, visual data, design data, large language model queries, real-time AI requests, and/or domain-specific prompts) presents challenges. Some traditional methods rely on static configurations, such as embedding customized prompts in application code or using fixed prompt manipulation strategies, leading to inefficiencies and increased latency. For example, when storing these customizations locally, systems wait for client-side code updates before beginning any prompt-focused processing, causing idle periods and resource underutilization. Alternatively, manual prompt configuration strategies can reduce idle time but introduce overhead, particularly as customizations become more specialized, which increases the number of redeployments and associated distribution complexity. Current methods are inadequate for facilitating scalable and consistent management of prompt-tuned models.

### SUMMARY

Implementations of the present disclosure relate to systems and methods for improving the server-side customization and processing of prompts in systems that provide outputs. Systems and methods are disclosed that can implement customized prompt-tuned model instances. For example, systems and methods in accordance with the present disclosure can use a storage to implement and/or otherwise manage prompt-tuned models and reference them independently from the base model. The model instances can reduce redundant code deployments, improve communication overhead, and improve prompt-based processing efficiency. For example, the disclosed implementations allow systems to process customized prompts on request, reducing the need for local code modifications while facilitating the usage of shared resources. The systems and methods can be applied in various contexts, including multi-tenant AI services, enterprise language model platforms, and real-time or near real-time applications such as conversational agents, digital avatar applications, cloud gaming instances, content-generation pipelines, and/or other technology areas or implementations.

Some implementations relate to a system including one or more processors to execute operations. The one or more processors to execute operations to receive, via an interface, a prompt and an identifier corresponding to a model instance. The one or more processors to execute operations to obtain, from a data source using the identifier, the model instance, the model instance including at least one customization applied to a base artificial intelligence (AI) model. In some implementations, at least one customization corresponds to an update to at least one parameter of the base AI model. The one or more processors to execute operations to apply the prompt as input to the model instance to cause the model instance to generate an output based at least on the at least one customization. The one or more processors to execute operations to provide, via the interface, the output for presentation.

In some implementations, the one or more processors are to execute operations to apply the prompt as input to the base AI model to generate a second output. In some implementations, the one or more processors are to execute operations to determine a performance metric based at least on applying an evaluation function to the output generated using the model instance and the second output generated using the base AI model. In some implementations, the one or more processors are to execute operations to deploy, to the data source, a new model instance by updating the at least one parameter of the base AI model based on the performance metric and updating at least one prompt tuning configuration. In some implementations, the deployment of the new model instance includes assigning the identifier or a new identifier to the new model instance.

In some implementations, the model instance includes an AI model based on the base AI model and at least one prompt tuning configuration implementing the at least one customization to the base AI model defined by the at least one parameter. In some implementations, the model instance and corresponding metadata is stored in the data source. In some implementations, the corresponding metadata includes at least the identifier and version information of the model instance.

In some implementations, the AI model is a prompt-tuned model generated by applying the at least one prompt tuning configuration. In some implementations, the at least one prompt tuning configuration updates modeling operations of the base AI model. In some implementations, prompt-tuning the prompt-tuned model includes updating at least one token embedding, attention mechanism, or activation function in the base AI model based on the at least one prompt tuning configuration. In some implementations, the update to the at least one parameter of the base AI model to generate the model instance includes updating at least one of (i) a task-specific parameter, (ii) a system parameter, (iii) a guardrail parameter, (iv) a template parameter, (v) a tool integration parameter.

In some implementations, applying the prompt as the input to the model instance to cause the model instance to generate the output is further based at least on identifying at least one tool for execution based on the prompt. In some implementations, applying the prompt as the input to the model instance to cause the model instance to generate the output is further based at least on provide, via at least one interface of the at least one tool, the prompt. In some implementations, applying the prompt as the input to the model instance to cause the model instance to generate the output is further based at least on receive, via the at least one interface, data corresponding with an execution of the at least one tool. In some implementations, the output generated by the model instance includes the data provided by the at least one tool.

In some implementations, the one or more processors are to execute operations to update the prompt based at least on at least one prompt configuration corresponding with the model instance. In some implementations, the updated prompt is applied as the input to the model instance. In some implementations, the model instance is obtained from the data source and configured for multi-client access in a client-server architecture. In some implementations, the one or more processors are to execute operations to receive, via the interface, a second prompt and the identifier corresponding to the model instance. In some implementations, the one or more processors are to execute operations to apply the prompt as input to the model instance to cause the model instance to generate a second output based at least on the at least one customization. In some implementations, the one or more processors are to execute operations to provide, via the interface, the second output.

Some implementations relate to one or more processors including processing circuitry to receive, via an interface, a prompt and an identifier corresponding to a model instance. In some implementations, the one or more processors including processing circuitry to obtain, from a data source using the identifier, the model instance including at least one customization applied to a base artificial intelligence (AI) model. In some implementations, the at least one customization corresponding to an update to at least one parameter of the base AI model. In some implementations, the one or more processors including processing circuitry to apply the prompt as input to the model instance to cause the model instance to generate a first output based at least on the at least one customization. In some implementations, the one or more processors including processing circuitry to apply the prompt as input to the base AI model to generate a second output. In some implementations, the one or more processors including processing circuitry to determine a performance metric based on applying an evaluation function to the first output generated using the model instance and the second output generated using the base AI model. In some implementations, the one or more processors including processing circuitry to update the model instance based on the performance metric. In some implementations, applying the evaluation function includes determining a similarity between the first output generated using the model instance and the second output generated using the base AI model using at least one of a statistical comparison function, a distance metric, or a probabilistic scoring model.

In some implementations, updating the model instance includes updating the at least one parameter of the model instance based on the performance metric by updating at least one of (i) a prompt tuning configuration, (ii) a weighting factor applied to at least one generated token probabilities, (iii) a constraint on response length, (iv) a task-specific embedding update, or (v) a fine-tuning parameter corresponding to decoding. In some implementations, updating the model instance includes storing the updated model instance in the data source with versioning metadata.

In some implementations, the model instance includes an AI model based on the base AI model and at least one prompt tuning configuration implementing the at least one customization to the base AI model defined using the at least one parameter. In some implementations, the model instance and corresponding metadata is stored in the data source. In some implementations, the corresponding metadata includes at least the identifier and version information of the model instance.

In some implementations, the AI model is a prompt-tuned model generated by applying the at least one prompt tuning configuration. In some implementations, the at least one prompt tuning configuration updates modeling operations of the base AI model. In some implementations, prompt-tuning the prompt-tuned model includes updating at least one token embedding, attention mechanism, or activation function in the base AI model based on the at least one prompt tuning configuration. In some implementations, the model instance is obtained from the data source and configured for multi-client access in a client-server architecture.

Some implementations relate to a method. The method includes receiving, via an interface, a prompt including an identifier corresponding to a model instance. The method includes obtaining, from a data source using the identifier, the model instance, the model instance including at least one customization applied to a base artificial intelligence (AI) model. In some implementations, the at least one customization corresponding to an update to at least one parameter of the base AI model. The method includes generate, using the model instance, an output based at least on the prompt and the at least one customization. The method includes providing, via the interface, the output.

In some implementations, the method includes applying the prompt as input to the base AI model to generate a second output. In some implementations, the method includes determining a performance metric based on applying an evaluation function to the output generated using the model instance and the second output generated using the base AI model. In some implementations, the method includes deploying, to the data source, a new model instance by updating the at least one parameter of the base AI model based on the performance metric and updating at least one prompt tuning configuration. In some implementations, the deployment of the new model instance includes assigning the identifier or a new identifier to the new model instance. In some implementations, the model instance includes an AI model based on the base AI model and at least one prompt tuning configuration implementing the at least one customization to the base AI model defined by the at least one parameter. In some implementations, the model instance and corresponding metadata is stored in the data source. In some implementations, the corresponding metadata includes at least the identifier and version information of the model instance.

The processors, systems, and/or methods described herein can be implemented by or included in at least one a system. The system can include a system for implementing customized models; a system for applying configurations to one or more models; a system for performing simulation operations; a system for performing real-time streaming; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a control system for an autonomous or semi-autonomous machine; a perception system for an autonomous or semi-autonomous machine; a system for performing digital twin operations; a system for performing light transport simulation; a system for performing remote operations; a system implemented using an edge device; a system implemented using a robot; a system for performing conversational AI operations; a system incorporating one or more virtual machines (VMs); a system implemented at least partially in a data center; and/or a system implemented at least partially using cloud computing resources.

### BRIEF DESCRIPTION OF THE DRAWINGS

The present systems and methods for server-side prompt-tuning for model customization are described in detail below with reference to the attached drawing figures, wherein:

FIG. 1 is a block diagram of an example of a system, in accordance with some implementations of the present disclosure;

FIG. 2 is a flow diagram of an example of a method for server-side prompt-tuning for model customization in a model customization pipeline, in accordance with some implementations of the present disclosure;

FIG. 3 is an example model architecture, in accordance with some implementations of the present disclosure;

FIG. 4A is a block diagram of an example generative language model system suitable for use in implementing at least some implementations of the present disclosure;

FIG. 4B is a block diagram of an example generative language model that includes a transformer encoder-decoder suitable for use in implementing at least some implementations of the present disclosure;

FIG. 4C is a block diagram of an example generative language model that includes a decoder-only transformer architecture suitable for use in implementing at least some implementations of the present disclosure;

FIG. 5 is a block diagram of an example computing device suitable for use in implementing at least some implementations of the present disclosure; and

FIG. 6 is a block diagram of an example data center suitable for use in implementing at least some implementations of the present disclosure.

### DETAILED DESCRIPTION

This disclosure relates to systems and methods for prompt-tuned model customization in server-based artificial intelligence (AI) architectures. Modern AI platforms (e.g., enterprise LLM/VLM/MMLM/etc. environments, multi-tenant inference services, conversational AI systems, cloud gaming systems, content streaming systems, and/or high-traffic generative pipelines) often include multiple systems, such as base model repositories, microservice components, and general-purpose compute systems (e.g., GPUs, CPU-based inference nodes, or dedicated hardware accelerators—e.g., for AI, computer vision, ray-tracing, etc.), to perform high-throughput text/audio/image/video/etc. processing tasks (e.g., real-time conversation handling, domain-specific text generation, and/or any data-intensive AI operations). Traditional methods for customizing prompts, such as client-side prompt insertion, can lead to inefficiencies due to repeated code deployments and inconsistent distribution. That is, traditional prompt tuning methods embed customization strings or logic within client-side code, forcing each application to adopt updates individually. For example, a development team can revise domain-related guardrails and re-release its application, while other applications remain unchanged, resulting in inconsistent usage of custom prompts. In this example, systems can wait for updated application code before referencing new prompt-based guardrails, resulting in delays. Additionally, distributing local configuration files to each client can reduce some overhead but can proliferate partial updates that are difficult to track, which can impact performance. Furthermore, when storing customizations locally and relying on client-side code updates, systems can experience delays in propagating improvements across distributed environments, leading to inconsistencies in model performance and user experience. That is, such an approach can exacerbate security risks, as sensitive prompt data or customization logic stored on individual devices can be more susceptible to unauthorized access or tampering compared to centralized server-side implementations.

In some implementations, some methods for server-side customization, such as static text-based configurations or manual repository adjustments, often cannot adequately balance latency reduction and resource usage. These approaches often fail to adapt dynamically (e.g., in response to real-time or near real-time operational parameters) to changes in domain requirements, user traffic, or model capabilities. For example, static references to prompt templates do not account for shifting workload patterns, and manual updates can introduce inconsistencies. Moreover, such methods can lack flexibility for different user scenarios, resulting in potential inefficiencies in large-scale AI services.

Systems and methods in accordance with the present disclosure facilitate improved model customization and scalability by allowing server-side prompt-tuned model creation, storage, and deployment. For example, the disclosed implementations can receive prompts and model identifiers via an interface, retrieve corresponding model instances stored in a repository, and apply the prompts to the model instances to generate outputs. In some implementations, the generated outputs can be evaluated against base model outputs using predefined evaluation functions to determine performance metrics. That is, the repository can store customized prompt-tuned models, including metadata and parameters (e.g., rules and/or values), facilitating management, distribution, and/or updates of model instances. In contrast to client-side prompt tuning or systems constrained by local customization, the disclosed implementations facilitate server-side management of prompt-tuned models, allowing improved deployment across multiple applications and dynamic updates.

Systems and methods in accordance with the present disclosure can store prompt-tuned models as instances within a repository (e.g., microservice-based). That is, at least one (e.g., each) prompt-tuned model can include at least one parameter (e.g., domain-specific constraints, style-related commands, or restricted content filters) that modifies a base model. For example, a user can generate and/or otherwise implement a prompt-tuned model for a domain and store it in repository under an identifier. Additionally, multiple prompt-tuned models can be stored, at least one (e.g., each) tuned for a different domain or usage scenario. In some implementations, a service and/or interface can retrieve the prompt-tuned models using the identifier. For example, when a prompt issues a request that references an identifier (e.g., model_instance_123), the systems and methods can apply the prompt to the corresponding prompt-tuned model with customizations.

In some implementations, the systems and methods can receive, via an interface, a prompt and an identifier corresponding to a model instance. Additionally, the system can obtain, from a data source using the identifier, the model instance include at least one customization applied to a base artificial intelligence (AI) model. For example, the at least one customization can correspond to an update to at least one parameter of the base AI model. In some implementations, the system can apply the prompt as input to the model instance to cause the model instance to generate an output based at least on the at least one customization. That is, the system can perform the customized operations defined by (e.g., using) the model instance. In some implementations, the system can provide, via the interface, the output for presentation. In some implementations, the system can apply the prompt as input to the base AI model to generate a second output and determine a performance metric based on applying an evaluation function (e.g., similarity metrics, accuracy calculations, confidence scoring) to the output generated (e.g., using) the model instance and the second output generated (e.g., using) the base AI model. Additionally, the system can update the model instance (or generate a new model instance) based on the performance metric. by implementing any one or more such operations, the systems and methods described herein provide improvements in prompt-tuning by addressing the technical limitations and problems of client-side prompt-tuning. That is, by performing prompt-tuning on the server-side, the disclosed systems and methods can improve the scalability, evaluation, and/or management of customized models, addressing the technical challenges related to distributing, updating, and evaluating prompt-tuned models in client-side implementations.

For example, a system can provide a prompt to a model instance to cause the model instance to generate an output based on at least one customization applied to a base AI model. The system can also apply the prompt to the base AI model to generate a second output and determine a performance metric by applying an evaluation function to compare the outputs from the model instance and the base AI model. The system can deploy a new model instance by updating parameters of the base AI model based on the performance metric and assigning an identifier to the new model instance. In some implementations, the system can store metadata associated with the model instance, including identifiers and version information. Furthermore, the model instance can include customizations defined by prompt-tuning configurations (e.g., apply instructions or logic that update the operations of the base model), such as updates to token embeddings, attention mechanisms, and/or activation functions. The system can update parameters of the base AI model to generate the model instance (e.g., a task-specific parameter, a system parameter, a guardrail parameter, a template parameter, a tool integration parameter). The system can also identify tools for execution (e.g., interfacing with external tools to enrich the output) based on the prompt and integrate data from these tools into the output generated by the model instance (e.g., offload tool-specific operations). Additionally, the system can update the prompt based on a configuration associated with the model instance, where the updated prompt is applied as input to refine the output further.

In some examples, the machine learning model(s) (e.g., deep neural networks, language models, LLMs, SLMs, VLMs, MMLMs, vision-language-action (VLA) models, perception models, tracking models, fusion models, transformer models, diffusion models, encoder-only models, decoder-only models, encoder-decoder models, neural rendering field (NERF) models, diarization models, transcription models, etc.) described herein can be packaged as a microservice—such an inference microservice (e.g., NVIDIA NIMs)—which can include a container (e.g., an operating system (OS)-level virtualization package) that can include an application programming interface (API) layer, a server layer, a runtime layer, and/or a model “engine.” For example, the inference microservice can include the container itself and the model(s) (e.g., weights and biases). In some instances, such as where the machine learning model(s) is small enough (e.g., has a small enough number of parameters), the model(s) can be included within the container itself. In other examples—such as where the model(s) is large—the model(s) can be hosted/stored in the cloud (e.g., in a data center) and/or can be hosted on-premises and/or at the edge (e.g., on a local server or computing device, but outside of the container). In such implementations, the model(s) can be accessible via one or more APIs—such as REST APIs. As such, and in some implementations, the machine learning model(s) described herein can be deployed as an inference microservice to accelerate deployment of a model(s) on any cloud, data center, or edge computing system, while ensuring the data is secure. For example, the inference microservice can include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which can include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein can be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice can include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some implementations, the inference microservice can include software to perform in-place replacement and/or updating to the machine learning model(s). When replacing or updating, the software that performs the replacement/updating can maintain user configurations of the inference runtime software and enterprise management software.

In some implementations, the system and methods described herein can be deployed in a talking or smart kiosk application. For example, a kiosk, tablet, smart display, or other device can include one or more onboard processors (e.g., CPUs, GPUs, deep learning accelerators, SoCs) and memory and/or storage (e.g., for storing the model, the image database, etc.). In some implementations, the kiosk/tablet/display can communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk can communicate with the machine learning model(s) (e.g., language model, LLM, SLM, VLM, MMLM, diffusion model, transformer model, NeRF, DNN, etc.) hosted on the local and/or remote servers using one or more APIs-such as, without limitation, REST APIs.

In one or more implementations, the system and methods described herein can be deployed in a gaming application. For example, a gaming console, PC, tablet, or other gaming device can include one or more onboard and/or remote processors (e.g., CPUs, GPUs, deep learning accelerators, SoCs) and memory and/or storage (e.g., for storing the game model, game assets, player data, etc.). These devices can use one or more machine learning models (e.g., diffusion models, transformer models, neural rendering field (NeRF) models, language models (e.g., LLMs, VLMs, SLMs, MMLMs, etc.), DNNs, etc.) to enhance gameplay, generate real-time dynamic content, and personalize user experiences based on in-game behavior or pre-stored player profiles. In some implementations, the system can be deployed in a cloud gaming environment (e.g., NVIDIA's GeFORCE NOW). In such cases, a client device (e.g., a smart display, tablet, or gaming controller) can be used to interact with the game, while the machine learning model(s) and/or visual rendering can occur on one or more remotely located servers/computing devices (e.g., in one or more data centers). The language model, AI processing, and rendering described herein can operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) can be used.

In some implementations, the system and methods described herein can be deployed in a video conferencing application. For example, a video conferencing device, such as a dedicated conferencing unit, computer, tablet, and/or smartphone, can include one or more onboard processors (e.g., CPUs, GPUs, deep learning accelerators, SoCs) and memory and/or storage (e.g., for storing the video, audio, or other communication-related data). The system can use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more implementations, the system can allows users to interact with the video conferencing platform using natural language inputs. For example, users can issue voice commands to schedule, join, or leave meetings, or to manage participants and screen sharing. During receiving and/or sending the data to and from the end-user or edge device(s), one or more data processing units (DPUs) and/or network interface cards (NICs) can be used.

In some implementations, the system and methods described herein can be deployed in a robotics application. For example, a robot or robotic system can include one or more onboard processors (e.g., CPUs, GPUs, hardware-based deep learning accelerators (DLAs), hardware-based programmable vision accelerators (PVAs)—which can include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system can use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system can use sensor fusion techniques to combine data from multiple sensors (e.g., cameras, infrared, LiDAR, RADAR, accelerometers) to create a comprehensive model of the robot's surroundings. This data can be processed locally on the robot or sent to remote servers for more computationally intensive tasks, such as 3D mapping or SLAM (Simultaneous Localization and Mapping). In one or more implementations, data from individual robots (e.g., sensor data, task status, or environmental conditions) can be uploaded to the cloud, where centralized AI models can analyze and distribute optimized commands to an entire fleet. In some implementations, the machine learning model(s) (e.g., language models, VLMs, SLMs, LLMs, MMLMs, vision-language-action (VLA) models, diffusion models, NeRF models, DNNs, etc.) described herein can be used to allow the robot to perceive and reason about the environment and/or communicate with one or more other robots and/or persons in an environment. In some implementations, the robot can communicate (e.g., using one or more network interface cards (NICs) and/or data processing units (DPUs)) with one or more locally hosted servers/computing devices and/or with one or more remotely located servers/computing devices (e.g., in one or more data centers).

In some implementations, the system and methods described herein can be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) can include one or more onboard processors (e.g., CPUs, GPUs, hardware-based deep learning accelerators (DLAs), hardware-based programmable vision accelerators (PVAs)—which can include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system can use these processors to execute one or more machine learning models (e.g., language models) to allow features such as voice control, personalized media recommendations, dynamic navigation, and real-time communication with other services through network connectivity. The in-vehicle infotainment system can also use natural language processing (NLP) models to allow voice-based interaction. The one or more machine learning models can be stored locally or accessed through one or more APIs that connect to cloud services, enabling the system to process requests in real time or near real-time.

In some implementations, one or more transformer engines (TEs) can be implemented. The transformer engine can use micro-tensor scaling to optimize performance and accuracy—such as to facilitate 16-bit floating point (FP16), 8-bit floating point (FP8), and/or 4-bit floating point (FP4) artificial intelligence processing. For example, the transformer engine can use 16-bit or 8-bit floating point precision and an 8-bit or 4-bit floating point data format combined with software algorithms for furth increasing AI performance and capabilities. By reducing math operations to 8-bits or 4-bits, the TE allows for training larger networks faster without compromising accuracy. For example, the TEs can include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which allow mixed-precision computing, such as microscaling precision support), server clusters can be more capable of training enormous networks at high speeds. As such, tensor core precisions of FP64, TF32, BF16, FP16, FP8, INT8, FP6, and FP4 can be supported, as well as CUDA core precisions of FP64, FP32, FP16, and BF16.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), vision-language-action (VLA) models, large action models (LAMs), etc.), and/or other types of machine learning models.

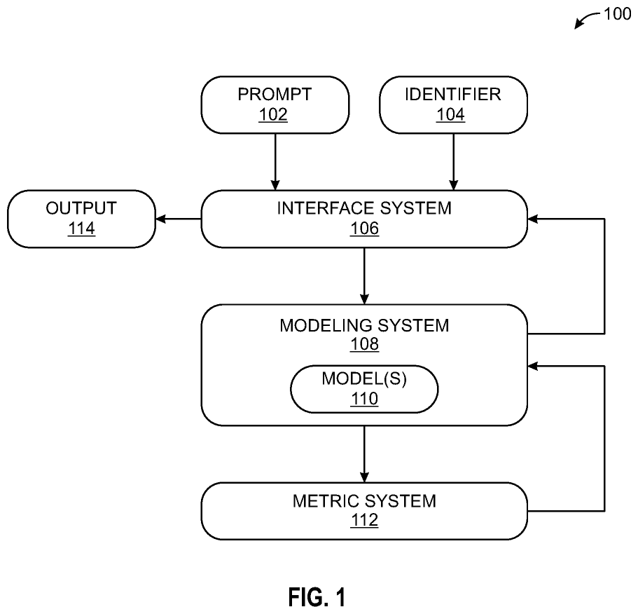

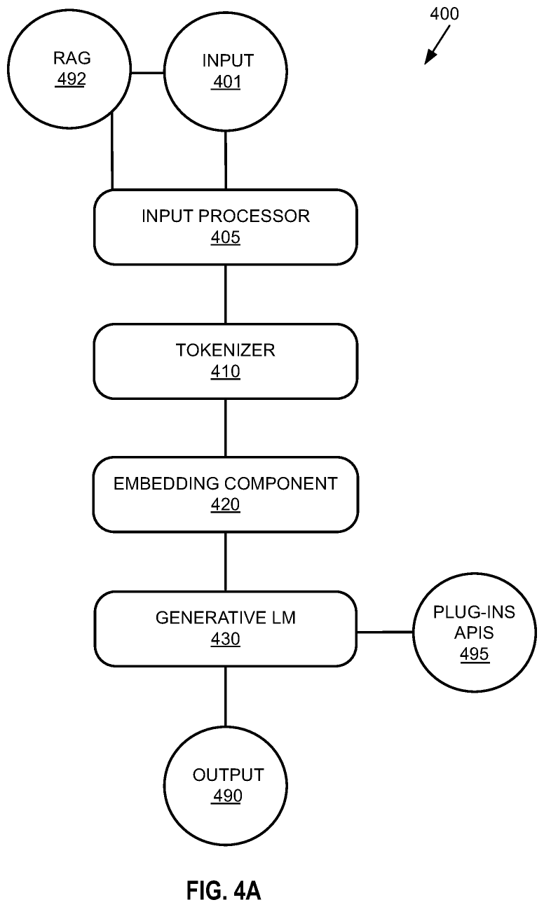

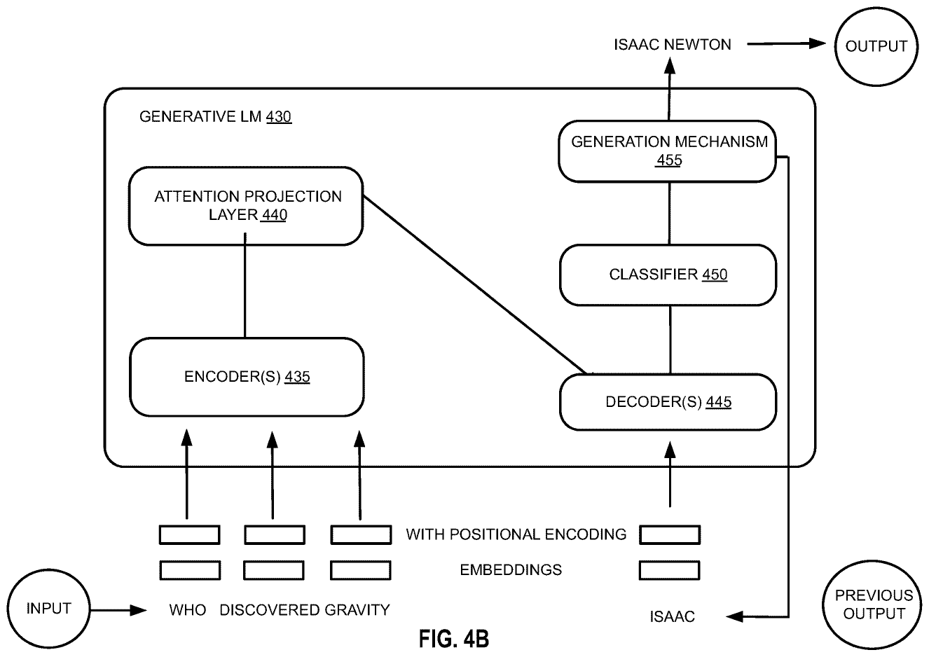

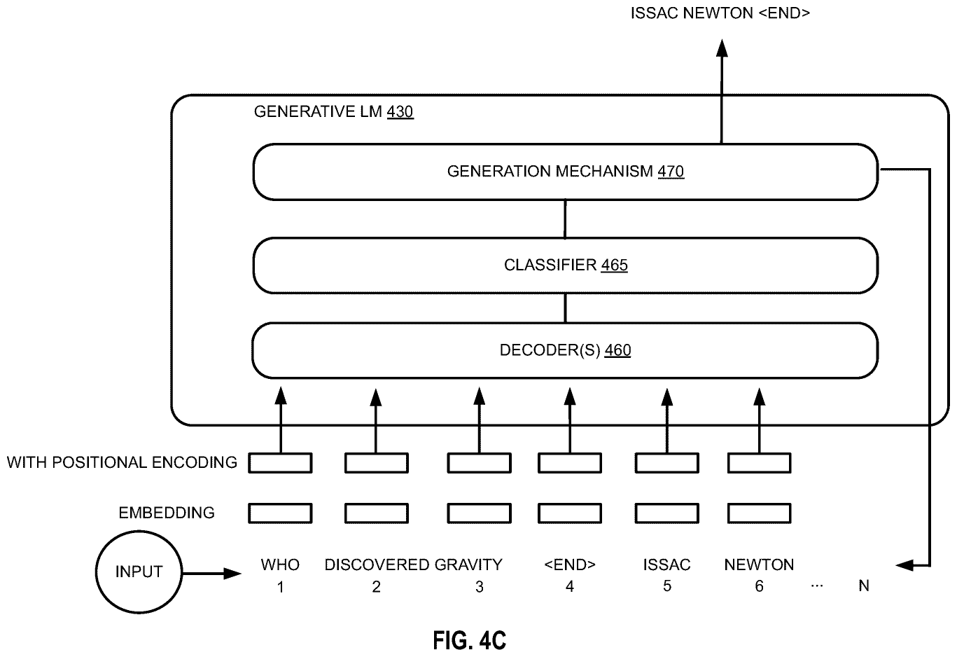

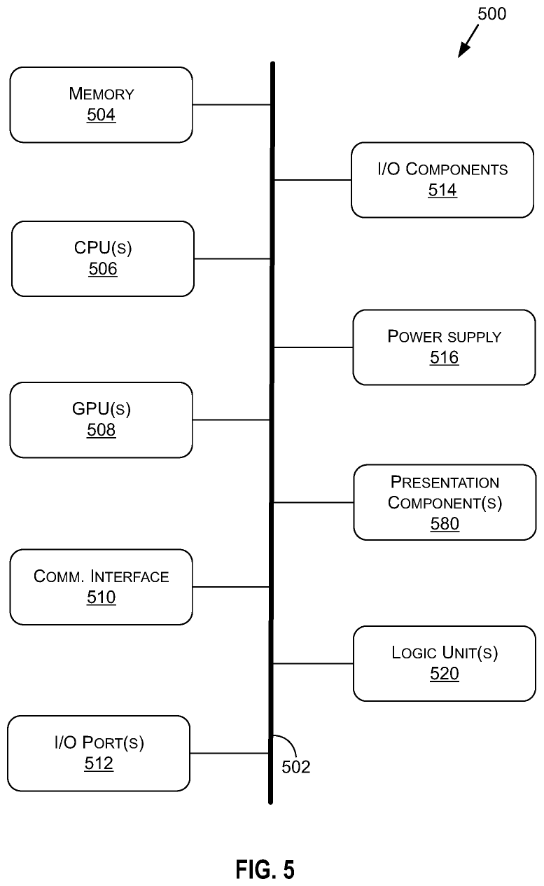

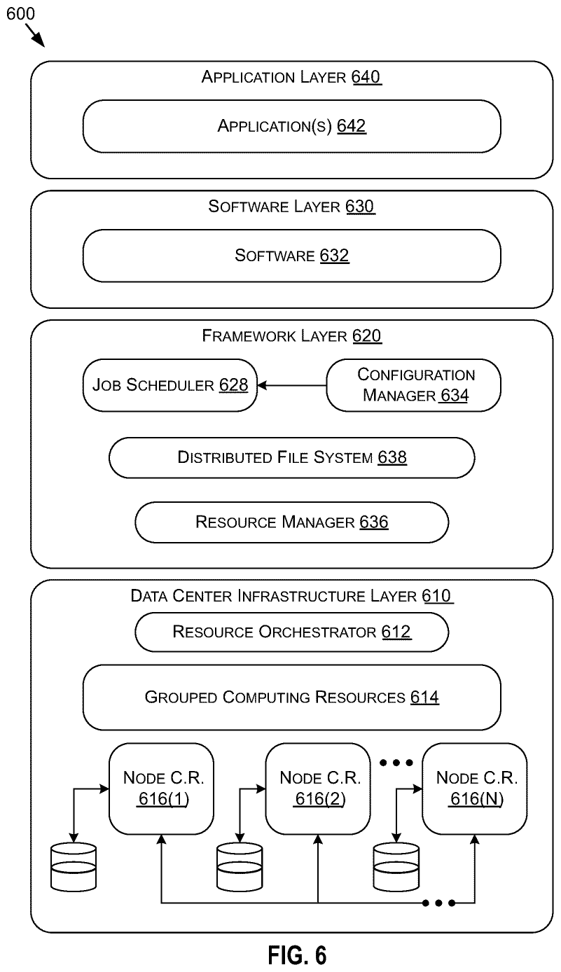

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 400 of FIG. 4A, example generative language model (LM) 430 of FIGS. 4B-4C, example computing device 500 of FIG. 5, and/or example data center 600 of FIG. 6.

The system 100 can implement at least a portion of a model customization pipeline, such as a fine-tuning pipeline, a prompt-tuning pipeline, or an inference-serving pipeline. The system 100 can be used to deploy customized model instances and/or manage versioned AI models by any of various systems described herein, including but not limited to a fine-tuning pipeline, a prompt-tuning pipeline, or an inference-serving pipeline. The system 100 can be used to deploy customized model instances and/or manage versioned AI models by any of various systems described herein, including but not limited to code generation systems, software deployment systems, machine learning operations (MLOps) systems, enterprise AI integration systems, natural language processing systems, enterprise automation systems, cloud-based AI platforms, embedded AI systems, developer toolchains, and/or multi-modal AI systems.

Generally, the model customization pipeline can include operations performed by the system 100. For example, the model customization pipeline can include any one or more of a prompting stage, a modeling stage, an updating stage, and/or an interfacing stage. Each stage of the model customization pipeline includes one or more components of the system 100 that perform the functions described herein. In some implementations, one or more of the stages can be performed during the training of AI models. Additionally, one or more of the stages can be performed during the inference phase using the AI models.

The system 100 (e.g., implementing the model customization pipeline) can receive, via an interface, a prompt and an identifier corresponding to a model instance. In some implementations, implementing the model customization pipeline can include the system 100 obtaining, from a data source using the identifier, the model instance. The model instance can include at least one customization applied to a base artificial intelligence (AI) model. Additionally, the at least one customization corresponding to an update to at least one parameter of the base AI model. Additionally, the implementing the model customization pipeline can include the system 100 applying the prompt as input to the model instance to cause the model instance to generate an output based at least on the at least one customization. Furthermore, the implementing the model customization pipeline can include the system 100 providing, via the interface, the output for presentation.

In some implementations, the implementing the model customization pipeline can include the system 100 applying the prompt 102 as input to the base AI model to generate a second output. Additionally, the implementing the model customization pipeline can include the system 100 determining a performance metric based on applying an evaluation function to the first output generated (e.g., using) the model instance and the second output generated (e.g., using) the base AI model. Furthermore, the implementing the model customization pipeline can include the system 100 updating the model instance based on the performance metric.

Generally, system 100 can facilitate server-side prompt tuning by deploying and/or applying customized prompt-tuned model instances. That is, system 100 can store, retrieve, and/or serve prompt-tuned models as distinct entities, addressing the technical limitations of client-side prompt tuning. For example, system 100 can receive, via an interface, a prompt 102 and an identifier 104 corresponding to a model instance stored in a centralized repository. The identifier 104 can reference a prompt-tuned model stored in a data source. By performing prompt tuning at the server level, system 100 can allow multiple users and applications to access and utilize the same customized model without requiring local modifications.

In some implementations, system 100 facilitates evaluation of prompt-tuned models by generating outputs from both the customized model instance and the base AI model. That is, system 100 can apply the prompt 102 to both models and compare the outputs using predefined evaluation functions (e.g., vector similarity measurements, probabilistic divergence metrics, sequence alignment algorithms, and/or any distance-based scoring functions). For example, system 100 can determine a performance metric by computing a similarity score, assessing divergence in response structures, and/or applying probabilistic scoring functions. By implementing server-side evaluation (e.g., automated output comparison, structured response validation, reinforcement learning-based tuning, and/or any model performance tracking mechanism), system 100 provides a quantifiable process for measuring the effectiveness of prompt-tuned models, addressing the technical challenge of assessing prompt modifications applied on the client-side.

Additionally, system 100 can allow deployment and update operations for prompt-tuned models. That is, system 100 can update prompt configurations, store new model versions, and/or distribute customized instances to connected applications (e.g., machine learning platforms, enterprise AI services, cloud-hosted inference engines, and/or any developer toolchains supporting AI model deployment). For example, system 100 can deploy an updated prompt-tuned model to a datastore and/or data source after evaluating its performance, reducing inconsistencies in model access across different users and applications. In some implementations, system 100 can integrate with a microservice (e.g., an inference microservice, such as NVIDIA's NeMo Inference Microservice (NIM)) to serve prompt-tuned models. That is, system 100 can execute inference requests using the deployed model instances, retrieve customized responses, and/or provide outputs to requesting clients. For example, system 100 can receive a software development prompt from one user and a data analysis prompt from another user, both utilizing the same customized prompt-tuned model instance. By implementing a centralized inference service, system 100 provides scalable access to prompt-tuned models without requiring client-side prompt modifications.

In some implementations, the prompting stage can be the stage in the model customization pipeline in which the system 100 can receive a request to generate an AI-driven response based on a selected model instance, retrieve the corresponding model instance from a data source, and prepare the input for processing. The system 100 can include at least one interface system 106. The interface system 106 can receive, via an interface, a prompt 102 and an identifier 104 corresponding to a model instance. That is, the interface system 106 can process input requests from external applications, validate the prompt format, and/or route the request to a model instance for execution.

The prompt 102 can be a text-based instruction, a structured query, a programmatic function call, an API request payload, and/or any machine-readable input. For example, during the prompting stage, the interface system 106 can parse the received prompt, extract relevant parameters, and/or determine an identified model instance for execution. The identifier 104 can be provided in the prompt 102 and/or provided as a separate metadata field, an API parameter, a request header, and/or within an external configuration file. The identifier 104 can be a model instance name, a version tag, a unique model identifier, a model deployment reference, and/or any structured key that associates the request with a specific model instance that identifies a model instance corresponding with a base model (e.g., Llama3, GPT-4, Gemini, Mistral) stored in a datastore and/or any database. For example, during the prompting stage, the interface system 106 can identify a request as requesting a specific fine-tuned model instance. In some implementations, the interface system 106 can receive and/or otherwise obtain the prompt 102 (e.g., including the identifier 104 and/or associated metadata) by processing an API call, listening for a message queue event, receiving user input via a client application, and/or reading from a pre-scheduled batch processing job.

In some implementations, the modeling stage can be the stage in the model customization pipeline in which the system 100 can retrieve, modify, and configure model instances for processing inference requests. The system 100 can include at least one modeling system 108. The modeling system 108 can obtain, from a data source using the identifier, the model instance (e.g., a model of model(s) 110). That is, the model instance can include at least one customization applied to a base artificial intelligence (AI) model. For example, the at least one customization can correspond to an update to at least one parameter (e.g., update an existing parameter and/or add a new parameter) of the base AI model. In some implementations, the modeling system 108 can obtain and/or otherwise retrieve the model instance by accessing a model datastore and/or data source storing model(s) 110. For example, during modeling stage the modeling system 108 can load a model instance into memory for inference execution. The parameter can be rules or values defining the specific behavior or constraints of the model 110 and the configuration can be a mechanism for implementing the changes in the AI model. The model instance can be a pre-customized version of a base model that is modified by applying specific customization (e.g., prompt tuning) without altering the underlying model weights. That is, the customization can reflect prompt tuning or similar lightweight updates applied to the base model (e.g., a model of model(s) 110).

Additionally, the modeling stage can be the stage in the model customization pipeline in which the system 100 can process inference requests using customized model instances. The modeling system 108 can apply the prompt as input to the model instance to cause the model instance to generate an output based at least on the at least one customization. That is, the modeling system 108 can use the prompt as input to the pre-customized version of the base AI model. For example, the customization can at least one of, but not limited to an update to task-specific parameters (e.g., customize the response for specific contexts), an update to system parameters (e.g., high-level guidance such as, topic control, behavioral control, ethical filters), an update to model alignment, such as guardrails and restrictions (e.g., to filter out inappropriate or undesired content), parameter adjustments (e.g., parameters tuned to influence responses without changing the underlying model weights), custom templates and/or formatting rules, and/or tool integration (e.g., if the question relates to weather, call the weather API). For example, during the modeling stage, the modeling system 108 can execute the model instance using the specified prompt, apply any necessary pre-processing and/or input formatting, and/or generate the corresponding model output. In some implementations, the modeling system 108 can apply and/or otherwise execute inference using the model instance by passing the structured input through the computational pipeline of the model and generate a response.

Generally, the model(s) 110 can be base models and/or a plurality of prompt-tuned model generated by applying the at least one prompt tuning configuration. The models can be prompt-tuned by the modeling system 108 performing predefined instructions to update internal components of the base AI model, such as token embeddings, attention mechanisms, and/or activation functions, in accordance with the customization logic specified by the prompt tuning configuration. That is, the at least one prompt tuning configuration updates modeling operations of the base AI model. For example, prompt-tuning the prompt-tuned model can include updating at least one token embedding, attention mechanism, and/or activation function in the base AI model based on the at least one prompt tuning configuration.

In some implementations, at least one prompt tuning configuration (e.g., instructions or logic that update the operations of the base model) of the model(s) 110 can implement at least one customization to the base AI model defined by the at least one parameter. The model instance and corresponding metadata is stored in the data source. Additionally, the corresponding metadata can include at least the identifier and version information of the model instance. In some implementations, the modeling system 108 can deploy and/or re-deploy, to the data source (e.g., model(s) 110), a new model instance by updating the at least one parameter of the base AI model based on a performance metric and/or updating at least one prompt tuning configuration. That is, the deployment of the new model instance can include assigning the identifier or a new identifier to the new model instance.

In processing inference requests, the modeling system 108 can identify at least one tool for execution based on the prompt. That is, the tool can be identified from the prompt by detecting specific keywords, structured command patterns, and/or predefined trigger phrases associated with external tool integrations. The modeling system 108 can provide tool integration to allow interfacing with external tools to enrich the output (e.g., offload processing operations to tools). The modeling system 108 can provide, via at least one interface of the at least one tool, the prompt. Additionally, the modeling system 108 can receive, via the at least one interface, data corresponding with an execution of the at least one tool. In some implementations, the output generated by the model instance can include the data provided by the at least one tool. For example, the output can state, “The current weather in New York City is sunny and 78 degrees Fahrenheit. You can visit Central Park with shorts and tee shirt.” In this example, the prompt can include “What is the current weather in New York City?” where the data provided by interfacing with the tool can include real-time weather information retrieved from an external weather API.

The modeling system 108 can include any one or more artificial intelligence models (e.g., machine learning models, supervised models, neural network models, deep neural network models), rules, heuristics, algorithms, functions, or various combinations thereof to perform operations including processing prompt inputs, generating structured outputs, and/or refining model-generated responses, such as applying prompt tuning, executing inference operations, and/or updating model parameters based on performance feedback. That is, model(s) 110 can be a neural network and/or machine-learning (ML) model trained to generate responses based on customized prompt configurations, optimize responses using fine-tuned parameters, and/or integrate external contextual information during inference.

In some implementations, the modeling system 108 can output structured text, numerical predictions, classification labels, ranking scores, or encoded representations (e.g., formatted natural language responses, confidence scores, vector embeddings, probability distributions, and/or any metadata associated with the model output). For example, the output can be a structured API response containing a formatted summary of an input document. In another example, the output can be a ranked list of retrieved entities relevant to the given input prompt. In some implementations, the generated outputs can be provided to modeling system 108 to perform post-processing operations such as response validation, re-ranking based on confidence scores, and/or contextual adaptation for downstream applications.

In some implementations, the modeling system 108 can maintain, execute, train, update, and/or otherwise process, refine, or apply one or more artificial intelligence (AI) models during the model customization stage. In some implementations, the AI model(s) can include any type of supervised, unsupervised, or reinforcement learning models capable of learning prompt-response mappings, optimizing inference accuracy, and adapting model parameters based on task-specific requirements (e.g., sequence-to-sequence models, transformer-based models) to generate coherent and contextually relevant outputs. For example, the AI model(s) can be trained and/or updated to refine response generation, improve retrieval-augmented inference, and maintain domain-specific consistency, among other model adaptation techniques.

The AI model(s) can be or include a transformer-based model (e.g., a generative pre-trained transformer (GPT) model, a bidirectional encoder representations from transformers (BERT)). The machine-learning model(s) can be or include a sequence-to-sequence (seq2seq) model, retrieval-augmented generation (RAG) model, and/or task-specific classification model, in some implementations. The modeling system 108 can execute the AI model to generate outputs. The modeling system 108 can receive data to provide as input to the AI model(s), which can include tokenized text, structured queries, pre-processed embeddings, execution parameters, and/or any reference data necessary for contextual inference.

In some implementations, the modeling system 108 can execute one or more AI models (e.g., model(s) 110) by utilizing a modeling framework to improve the performance of the AI model during fine-tuning. The framework can include implementing techniques such as gradient descent, backpropagation, and distributed training to improve model parameters on large-scale datasets. The AI model(s) can incorporate mechanisms such as dropout regularization, attention weight pruning, and/or dynamic learning rate adjustments to maintain efficiency and prevent overfitting.

For example, during execution, the modeling system 108 can partition input data into mini-batches, apply loss functions, and update model parameters iteratively. The AI models can support inference operations that include processing feature vectors, transforming raw input data, and generating probabilistic predictions and/or metrics. The modeling system 108 can integrate hardware accelerators such as GPUs or TPUs to scale computational workloads, reduce latency in inference tasks, and parallelize gradient updates, for example when handling large-scale prompt-tuned model instances across multiple concurrent requests.

In some implementations, the modeling system 108 can evaluate trained models using various metrics (e.g., precision, recall, and/or F1 score) and/or any task-specific evaluation functions to determine readiness for deployment and/or inference operations. The evaluation can include analyzing model performance on validation datasets, testing datasets, or real-world data inputs to assess consistency and robustness. For example, the modeling system 108 can compare model predictions against ground truth data to determine accuracy metrics, confidence thresholds, and/or response quality assessments. In another example, the modeling system 108 can track performance variations over multiple evaluation cycles to identify model drift, output inconsistencies, and/or degradation in prompt adherence. The evaluation can include the modeling system 108 applying techniques such as cross-validation, Monte Carlo simulations, and/or adversarial testing to measure resilience against noisy inputs, systematic biases, and/or domain adaptation errors.

In some implementations, the modeling system 108 can generate performance metrics and/or data structures including metric values, confusion matrices, and/or calibration plots to identify model effectiveness. The performance metrics and/or data structures can be used to facilitate retraining procedures, model adjustments, and/or fine-tuning processes if evaluation criteria are not met. The modeling system 108 can integrate threshold-based criteria, such as enforcing an F1 score above a predefined value, before permitting the model(s) 110 to be deployed for inference. In some implementations, model evaluation can include automated testing pipelines that perform predefined test cases, analyze false positive and false negative rates, and/or apply statistical significance tests to validate improvements.

In some implementations, the modeling system 108 can include at least one AI model (e.g., model(s) 110). The model(s) 110 can include an input layer, an output layer, and/or one or more intermediate layers, such as hidden layers, which can at least one (e.g., each) have respective nodes. That is, the model(s) 110 process input data through multiple computational stages to generate an output based on learned representations. For example, the input layer receives tokenized prompts, encoded feature vectors, or structured numerical data for processing. For example, the output layer produces a response, classification, or numerical prediction based on the processed information. For example, the intermediate layers apply transformations, attention mechanisms, and/or activation functions to refine the understanding and response accuracy of the model(s) 110.

In some implementations, the system 100 can configure (e.g., train, update, fine-tune, apply transfer learning to) the model(s) 110 by modifying or updating one or more parameters, such as weights and/or biases, of various nodes of the model(s) 110 responsive to evaluating estimated outputs of the model(s) 110 (e.g., generated in response to receiving training examples in a training dataset, such as a training dataset including application-specific prompt-response pairs, structured query interactions, and/or multi-turn conversation logs). The modeling system 108 can be or include various neural network models, including models that can operate on or generate data including but not limited to text sequences, structured data, embeddings, images, audio, and/or combinations thereof.

In some implementations, the modeling system 108 can be configured (e.g., trained, updated, fine-tuned) based at least on the training data of the at least one training dataset (e.g., task-specific datasets, domain-adapted corpora, structured knowledge bases). For example, one or more example prompt inputs and/or expected responses of the training data can be applied (e.g., by the system 100 and/or in a pre-training and/or tuning process performed by the system 100 or another system) as input to the modeling system 108 to cause the modeling system 108 to generate an estimated output. The estimated output can be evaluated and/or compared with ground truth labels (or expected model behavior) of the training data that correspond with the one or more example inputs and/or responses, and the model(s) 110 of the modeling system 108 can be updated based at least on the performance deviation and/or error minimization. For example, based at least on an output of a prompt-tuned task, one or more parameters of model(s) 110 of the modeling system 108 can be updated.

In some implementations, the modeling system 108 can implement and/or otherwise facilitate a pre-training in which model(s) 110 is trained on large-scale, unstructured datasets to learn foundational representations (e.g., token embeddings, attention weight distributions, hierarchical feature structures). The pre-training can include self-supervised learning techniques such as masked token prediction, next-token prediction, contrastive learning, and/or denoising objectives to develop generalized feature representations. For example, model(s) 110 can be exposed to large corpora of technical documentation, structured datasets, and/or conversational logs to extract statistical patterns, semantic relationships, and/or latent structures. In another example, model(s) 110 can apply unsupervised clustering techniques to identify recurrent patterns and correlations in the training data (e.g., syntax patterns, phrase alignment, hierarchical dependencies). The pre-training phase can include updating model parameters based on loss functions computed from predicting missing or corrupted data points. The modeling system 108 can apply distributed training techniques, including data parallelism, model parallelism, and/or pipeline parallelism, to optimize the computational efficiency of pre-training. The output (e.g., generalized model embeddings, trained token representations, optimized parameter matrices) of the pre-training phase can be used to initialize model(s) 110 for subsequent fine-tuning on domain-specific tasks.

In some implementations, the modeling system 108 can implement and/or otherwise facilitate fine-tuning in which model(s) 110 is updated to specific tasks (e.g., software code generation, structured text completion, data transformation) using domain-specific training datasets (e.g., internal development logs, enterprise API interactions, domain-restricted documentation). The fine-tuning process can include supervised learning, reinforcement learning, and/or contrastive learning to refine the pre-trained representations. For example, the modeling system 108 can adjust weight distributions, recalibrate loss functions, and/or prioritize specific response structures based on training feedback. The modeling system 108 can update model(s) 110 by adjusting weights, biases, and/or layer-specific parameters based on task-specific loss functions. For example, fine-tuning can include backpropagation-based updates using labeled datasets where model(s) 110 can be trained to minimize classification errors, prediction uncertainties, and/or inference inconsistencies.

In some implementations, fine-tuning can be performed using techniques such as low-rank adaptation (LoRA), adapter layers, and/or selective parameter freezing to reduce computational costs while preserving generalization capabilities. The modeling system 108 can iteratively evaluate model(s) 110 on validation datasets (e.g., benchmarking datasets, historical API request logs, and/or structured enterprise task evaluations) to track performance changes, mitigate overfitting, and/or determine convergence criteria. Fine-tuning outputs can be evaluated against reference benchmarks (e.g., domain-specific evaluation metrics, operational performance thresholds, and/or security compliance standards) to assess task alignment, efficiency improvements, and/or robustness against adversarial inputs.

In some implementations, the modeling system 108 can implement and/or otherwise facilitate retrieval-augmented generation (RAG) models to improve output quality of model(s) 110 by incorporating external knowledge sources. The RAG architecture can include a retrieval system and a generation system, where the retrieval system of modeling system 108 can fetch relevant documents, embeddings, or structured data (e.g., semantic search indices, vector embeddings, relational database records) from knowledge bases (e.g., internal documentation repositories, cloud-hosted API catalogs, enterprise codebases), and the generation system of modeling system 108 can synthesize responses using retrieved content. The modeling system 108 can utilize vector search techniques such as FAISS, approximate nearest neighbor (ANN) search, and/or BM25 ranking to identify relevant retrieval candidates. For example, model(s) 110 can retrieve contextually relevant passages (e.g., prior query responses, structured template references, metadata-enriched documents) from an indexed database and use the retrieved content as additional input for generating responses.

In some implementations, the modeling system 108 can dynamically update retrieval parameters based on query complexity, information density, and/or response ambiguity. The retrieval process can be reinforced using feedback mechanisms, where low-confidence generations trigger additional retrieval iterations. The modeling system 108 can integrate hybrid approaches that combine parametric memory from model(s) 110 with non-parametric retrieval sources to balance computational efficiency and factual accuracy.

In some implementations, the modeling system 108 can implement and/or otherwise facilitate a sparse expert-based model architecture. The model(s) 110 can utilize a Mixture of Experts (MoE) framework, where a subset of expert networks can be dynamically activated per inference step based on input characteristics. For example, when a structured SQL query (e.g., input) is received, the model(s) 110 can activate an expert sub-network trained on database query optimization. The MoE structure can include multiple specialized sub-networks, at least one (e.g., each) trained on different aspects of data processing, and a gating mechanism that selects the relevant experts for a given query. In some implementations, the modeling system 108 can include optimizations such as multi-head latent attention, which reduces memory overhead by compressing and reconstructing key-value pairs dynamically, minimizing cache storage requirements during inference. The model(s) 110 can integrate both local and global attention mechanisms, where local attention can process immediate token relationships and global attention can capture long-range dependencies.

Additionally, the model(s) 110 can implement soft token merging to reduce redundant input tokens and dynamic token inflation to restore critical details during later processing stages. For example, the model(s) 110 can compress functionally equivalent tokens in multi-turn conversations and expand necessary details in retrieval-augmented responses. The modeling system 108 can further improve inference performance by employing hardware acceleration techniques, including tensor parallelism and/or memory-efficient caching strategies. The system 100 can execute the sparse expert-based model architecture (e.g., model(s) 110) for enterprise automation, structured data transformation, domain-specific reasoning, and/or multimodal AI applications.

In some implementations, during model updating and/or training, the modeling stage can be the stage in the model customization pipeline in which the system 100 can compare outputs from the customized model instance and a base AI model. The modeling system 108 can apply the prompt as input to the base AI model (e.g., a model of model(s) 110) to generate a second output. That is, the modeling system 108 can execute the base AI model without any applied customizations to establish a performance benchmark. For example, during the modeling stage, the modeling system 108 can process the same prompt through the base AI model and generate an unmodified response for comparison against the customized model instance. In some implementations, the modeling system 108 can apply and/or otherwise perform inference with the base AI model to generate a second output by applying the model parameters, generating an output based on default configurations, and retrieving the raw response for evaluation.

In some implementations, during model updating and/or training, the updating stage can be the stage in the model customization pipeline in which the system 100 can evaluate the difference between outputs from the customized model instance and the base AI mode. The system 100 can include at least one metric system 112. The metric system 112 can determine a performance metric based on applying an evaluation function to the first output generated by the model instance and the second output generated by the base AI model. That is, the evaluation function can include determining a similarity (e.g., lexical similarity, semantic similarity, syntactic similarity, probability-based similarity, embedding distance, and/or task-specific similarity) between the first output generated (e.g., using) the model instance and the second output generated (e.g., using) the base AI model using (e.g., cosine similarity function, token-level edit distance, and/or log-likelihood comparison of token distributions) at least one of a statistical comparison function, a distance metric, and/or a probabilistic scoring model.

For example, the prompt 102 can state “How should errors be logged?” In this example, the model instance can generate an output stating, “Use logger.error(message).” Additionally, in this example, the base AI model can generate an output stating, “Use print(‘Error:’, message).” In this example, a consistency scoring function can be applied as the evaluation function where the generated outputs are compared based on alignment with internal coding practices, prioritizing structured logging over generic print statements. That is, the metric system 112 can provide the performance metric to the modeling system 108 to update and/or otherwise refine the model instance (e.g., a specific model of model(s) 110).

In another example, the prompt 102 can state “What is the weather in Santa Clara, CA?” In this example, the model instance can generate an output stating, “The current temperature in Santa Clara, CA is 72° F. with clear skies, retrieved from a live weather API.” Additionally, in this example, the base AI model can generate an output stating, “On average, Santa Clara, CA has a temperature of 70° F. on this day based on historical data.” In this example, a relevance scoring function can be applied as the evaluation function where the accuracy and timeliness of the response are compared, prioritizing real-time data over historical estimates. That is, the metric system 112 can provide the performance metric to the modeling system 108 to update and/or otherwise adjust the model instance to improve reliance on external sources when available (e.g., a specific model of model(s) 110).

Additionally, the modeling stage can be the stage in the model customization pipeline in which the system 100 can adjust model parameters based on the determined performance metric. The modeling system 108 can update the model instance based on the performance metric. That is, the modeling system 108 can updating the model instance (e.g., model 110) can include updating the at least one parameter of the model instance based on the performance metric. In some implementations, updating the at least one parameter of the base AI model to generate the model instance can include updating at least one of a task-specific parameter, a system parameter, a guardrail parameter, a template parameter, a tool integration parameter, and/or any other fine-tuning adjustment related to response generation, model behavior, and/or structured output formatting. That is, the parameter can be a rule and/or value (e.g., updating formality level, suppressing specific topics, prioritizing domain-specific vocabulary, limiting responses to specific languages, enforcing ethical guardrails, excluding sensitive or restricted content, optimizing output length, updating confidence thresholds for token probabilities) used to implement prompt tuning configurations (e.g., modify token embedding, modify activation function, modify attention mechanism).

In some implementations, updating the parameter by the modeling system 108 can include updating (e.g., training) a prompt tuning configuration, a weighting factor applied to at least one generated token probabilities, a constraint on response length, a task-specific embedding update, and/or a fine-tuning parameter corresponding to decoding. For example, without altering the underlying model weights, the modeling system can apply a specific customization (e.g., prompt tuning) that can update token embeddings, update sequence generation behavior, and/or refine response structuring. Additionally, the modeling system 108 can store the updated model instance in the data source with versioning metadata (e.g., in a data source storing the model(s) 110).

In some implementations, the interfacing stage can be the stage in the model customization pipeline in which the system 100 can transmit, encode, or format the generated output for consumption by downstream systems, user interfaces, and/or data processing pipelines. The interface system 106 can provide and/or otherwise package the output in a structured format, append metadata, and/or optimize the output for transmission, via the interface, for presentation or further computational use. That is, the interface system 106 can convert the output into a standardized response format (e.g., JSON, XML), apply post-processing transformations (e.g., filtering, truncation, formatting adjustments), and/or queue the output for asynchronous delivery in event-driven architectures. For example, during the interfacing stage, the interface system 106 can route the output to a frontend application for rendering, transmit the output to an API client over a network connection, and/or store the output in a database.

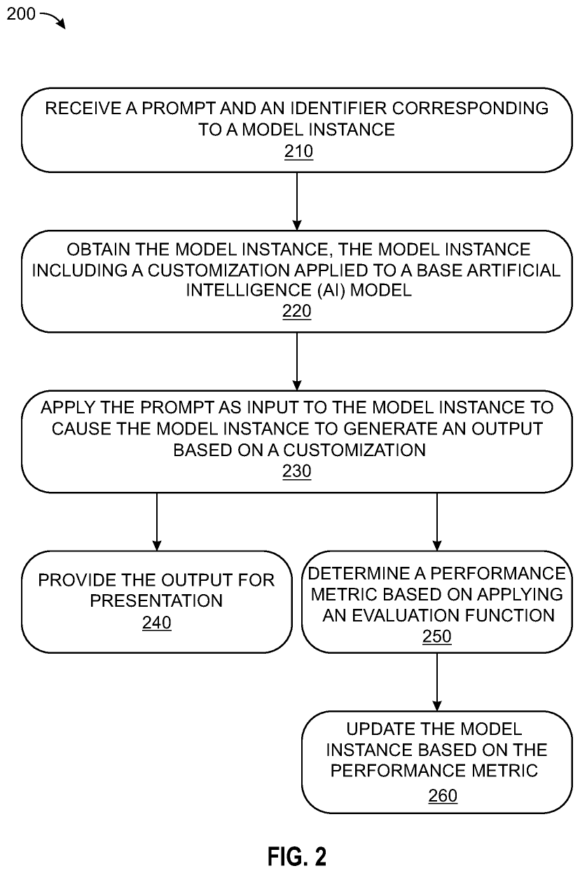

With reference to FIG. 2, an example flow diagram illustrating a method for server-side prompt-tuning for model customization in a model customization pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 4A-4C), one or more computing devices or components thereof (e.g., as described in FIG. 5), and/or one or more data centers or components thereof (e.g., as described in FIG. 6).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for receiving, obtaining, applying, generating, providing, determining, and/or updating operations (among other operations), in accordance with some implementations of the present disclosure. Various operations of method 200 can relate to improving the scalability and efficiency of prompt-tuned AI model deployment. Existing systems often rely on and/or use client-side prompt tuning, which can lead to fragmented model customization, difficulties in distributing updates, and challenges in evaluating performance consistently. The existing technological problems can arise when these systems apply prompt modifications locally without centralized management, resulting in inconsistent model behavior, limited scalability, and difficulties in maintaining version control across multiple users or applications. Method 200 of FIG. 2 can solve these technological problems by implementing server-side prompt-tuned model storage, retrieval, and evaluation, thereby improving model management, performance tracking, and deployment flexibility.

The systems and methods described herein can be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations can be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

FIG. 2 is a flow diagram depicting a method 200 for receiving, obtaining, applying, generating, providing, determining, and/or updating operations (among other operations), in accordance with some implementations of the present disclosure. Various operations of method 200 can relate to improving the scalability and efficiency of prompt-tuned AI model deployment. Existing systems often rely on and/or use client-side prompt tuning, which can lead to fragmented model customization, difficulties in distributing updates, and/or technical challenges in determining performance consistently. The existing technological problems can arise when these systems apply prompt modifications locally without centralized management, resulting in inconsistent model behavior, limited scalability, and difficulties in maintaining version control across multiple users or applications. Method 200 of FIG. 2 can solve these technological problems by implementing server-side prompt-tuned model storage, retrieval, and evaluation, thereby improving model management, performance tracking, and deployment flexibility.

The method 200, at block 210, includes receiving, via an interface, a prompt and an identifier corresponding to a model instance. In some implementations, the processing circuits can receive a prompt including an identifier corresponding to a model instance. That is, the interface can be an inference microservice (e.g., NVIDIA NIM), a model-serving gateway, a cloud-based inference API, and/or any application programming interface (API) that can be implemented to receive the prompt and/or identifier (e.g., include or separate from the prompt) as input. For example, the processing circuits can receive an API request and/or any other gateway request containing a structured data payload specifying the prompt and the identifier (e.g., in fields) and/or an unstructured input where the identifier is embedded within the prompt text and extracted.

In some implementations, the identifier can identify a model instance corresponding with a base model (e.g., Llama3, GPT-4, Gemini) stored in a data source (e.g., NeMo datastore, S3 storage, vector database). For example, the identifier can be an identifier of a model instance of Llama, such as Llama-3.2-Model_Instance_A12, GPT-4o-MS_V8, Gemini-Model-Instance-B5. Additionally, the prompt can be a text-based instruction, a structured query, or a natural language request. That is, the prompt can define a task, request a model response, include an identifier, and/or include contextual information for generating an output. For example, the prompt can be “Summarize this document in one paragraph.” In another example, the prompt can include the identifier and can be “Use Model_Instance_A12 to generate a summary.” In yet another example, the prompt including the identifier can be “Generate a skeleton Python application using my most used model instance with a basic API endpoint.”

In some implementations, the prompt can include the identifier such that the processing circuits can associate the request with the corresponding model instance without requiring separate metadata transmission. For example, the processing circuits can receive a data package (e.g., a JSON payload, a message, an HTTP request) including the prompt. In this example, the processing circuits can identify the identifier in the prompt by parsing a field (e.g., structured) and/or content (e.g., unstructured), identifying a model-specific tag and/or contextual keywords, and/or extracting key-value pairs from the request.

In some implementations, the prompt can include a command alias and an input indicating the model without indicating the model instance by name. For example, the prompt can include a directive that states “pull customization b.” In this example, the processing circuits can identify the model corresponding with “customization b” by querying a mapping table and/or lookup database storing predefined associations between aliases and model instances. In another example, the prompt can include a directive that states “use my most used model.” In this example, the processing circuits can identify the model corresponding with the “most used model” by retrieving user interaction logs, ranking and/or identifying previously accessed models based on usage frequency, and selecting the highest-ranked model.

In some implementations, the identifier can be provided as a separate component of the received data such that it is transmitted as metadata rather than embedded in the prompt text. That is, the processing circuits can extract the identifier from the metadata and use it to retrieve the corresponding model instance before processing the prompt. For example, an API request can include a “model_instance_id” parameter separate from the text input, facilitating independent model selection without modifying the prompt of the user.

In some implementations, the processing circuits can update the prompt based at least on at least one prompt configuration (e.g., predefined modifications such as, but not limited to, guardrails, behavioral instructions, injecting specific context, and/or restrictions) corresponding with the model instance. That is, the processing circuits can updates the received prompt by applying the server-side customization. For example, the processing circuits can append contextual metadata, enforce response constraints, and/or restructure the prompt to align with predefined formatting requirements before applying it as input to the model instance. The updated prompt can be applied as the input to the model instance (at block 240).

The method 200, at block 220, includes obtaining, from a data source using the identifier, the model instance, the model instance comprising at least one customization applied to a base artificial intelligence (AI) model, the at least one customization corresponding to an update to at least one parameter of the base AI model. In some implementations, the model instance can be a pre-customized version of a base model that is modified by applying specific customization (e.g., prompt tuning, template-based response modification, context injection) without altering the underlying model weights. That is, the customization can reflect prompt tuning or similar lightweight updates applied to the base model. For example, a customization can be updating an existing parameter and/or adding a new parameter. In another example, a customization can be adjusting fine-tuning parameters to bias the model toward domain-specific terminology without modifying existing knowledge. In yet another example, a customization can be applying low-rank adaptation (LoRA) fine-tuning to modify attention weights for improved response coherence in specialized tasks.

In some implementations, the parameter can be a rule and/or value defining the specific behavior or constraints of the model. For example, a parameter can specify a fine-tuning adjustment such as modifying learning rate schedules for selected layers, setting weight decay values for stability, or constraining gradient updates to specific neural network modules. Additionally, a configuration can be a mechanism for implementing the changes in the AI model. That is, the processing circuits can apply adapter-based fine-tuning techniques, such as adding trainable low-rank projection matrices between transformer layers, and/or using parameter-efficient fine-tuning (PEFT) methods, such as LoRA to modify attention scores without updating the full model weight space. For example, the processing circuits can inject fine-tuning parameters into a frozen pre-trained model by dynamically loading adapter modules during inference, facilitating domain-specific adaptation.

In some implementations, the model instance can include an AI model based on the base AI model and at least one prompt tuning configuration implementing the at least one customization to the base AI model. That is, implementing the customization can include applying and/or otherwise modifying model execution logic that updates the operations of the base model. For example, the customization can be defined by the at least one parameter (e.g., task-specific constraints, response formatting rules, domain adaptation weights, token selection biases, and/or decoding adjustments). In some implementations, the model instance and corresponding metadata can be stored in the data source (e.g., datastore, a vector database, an object storage system, and/or a distributed model registry). Additionally, the corresponding metadata can include at least the identifier (e.g., model_instance_123, instance_X45, fine-tuned_v7, and/or enterprise_model_A1) and version information (e.g., v2.1-customization for a specific use case of a custom generative AI, revision_4.3, latest_fine_tune_5, and/or test_deployment_2025) of the model instance. For example, a model instance can be stored with its training metadata, including hyperparameter configurations, fine-tuning dataset references, and update timestamps to maintain traceability of modifications.

In some implementations, the AI model (e.g., model instance(s)) can be a prompt-tuned model generated by applying the at least one prompt tuning configuration. That is, the at least one prompt tuning configuration can update modeling operations of the base AI model. Prompt-tuning the prompt-tuned model can include updating at least one token embedding, attention mechanism, and/or activation function in the base AI model based on the at least one prompt tuning configuration.

In some implementations, the prompt tuning configuration can be any modification applied to model execution to guide response behavior, such as, but not limited to, soft prompt embeddings, prefix tuning, re-ranking constraints, and/or instruction-based conditioning. For example, a prompt tuning configuration can include modifying the embedding space of initial token representations to bias the contextual understanding of the model toward domain-specific terminology. That is, the processing circuits can perform predefined instructions to adjust internal components of the base AI model, such as, but not limited to, token embeddings, attention mechanisms, and/or activation functions, in accordance with the customization logic (e.g., adaptive prompt injection strategies, hierarchical attention weighting, and/or probabilistic response sampling constraints) specified by the prompt tuning configuration. For example, a customization logic can modify self-attention mechanisms to prioritize retrieval-augmented (e.g., RAG) responses over generative outputs based on predefined conditions. In another example, a prompt tuning configuration can update transformer decoder layers to increase coherence when generating long-form responses while maintaining token efficiency.

In some implementations, the update to the at least one parameter of the base AI model to generate the model instance can include updating at least one of (i) a task-specific parameter, (ii) a system parameter, (iii) a guardrail parameter, (iv) a template parameter, (v) a tool integration parameter. That is, the processing circuits can apply structured parameter modifications to refine inference behavior without modifying full model weights. For example, the processing circuits can update rules or values (e.g., updating response specificity, updating sentiment biases, applying structured formatting constraints, enforcing conversational tone consistency, prioritizing retrieval-based augmentation, enforcing compliance with predefined ethical guardrails, restricting output to approved taxonomies, and/or updating temperature values for controlled randomness) used to implement prompt tuning configurations (e.g., updating token embedding initialization, updating activation function behavior, and/or updating attention distribution constraints).

In some implementations, the model instance can be obtained from the data source and configured for multi-client access in a client-server architecture (e.g., client-server distinction where multiple users can obtain responses using a shared server-side configuration without using local processing resources). That is, the client-server architecture can be distributed across cloud-based inference nodes, containerized AI model services, and/or edge computing infrastructure and can be implemented to optimize response latency, manage multi-tenant model deployment, and/or facilitate scalable model instance retrieval across multiple user sessions. For example, a centralized AI model registry can store multiple versions of customized model instances, allowing different users to query specific versions based on assigned permissions and/or usage policies.

Additionally, the processing circuits can receive, via the interface, a second prompt and the identifier corresponding to the model instance. That is, the second prompt can be from a different user but for the same model instance. In some implementations, the processing circuits can apply the prompt as input to the model instance to cause the model instance to generate a second output based at least on the at least one customization. For example, a first user can submit a prompt to generate a REST API endpoint in Python, and a second user can submit a prompt to generate a database schema in SQL, both utilizing the same customized model instance that includes prompt tuning for software development and code generation. Additionally, the processing circuits can provide, via the interface, the second output (e.g., for presentation, API response transmission, and/or integration with downstream systems).

The method 200, at block 230, includes applying the prompt as input to the model instance to cause the model instance to generate an output based at least on the at least one customization. In some implementations, the processing circuits can generate, using the model instance, an output based at least on the prompt and the at least one customization. That is, the processing circuits (e.g., implementing the inference microservice) can use the prompt as input to the pre-customized version of the base AI model (e.g., retrieved from the data source, such as a NeMo datastore). For example, the processing circuits can execute inference using the model instance, retrieve any stored prompt-handling parameters associated with the customization, and/or apply the customized inference rules defined by the model instance during response generation.

In some implementations, the at least one customization can be any modification applied to the inference process without requiring full model retraining. For example, the customization can be adding and/or updating at least one task-specific parameter to customize the response for specific contexts. In this example, the customization can be implemented in the base model to generate a customized model instance by updating prompt conditioning variables, loss function weighting for task relevance, and/or token selection probabilities during inference. In another example, the customization can be adding and/or updating at least one system parameter to provide high-level guidance to the model instance (e.g., topic control, behavioral control, ethical filters). In this example, the customization can be implemented in the base model to generate a customized model instance by applying reinforcement learning-based response modulation and/or enforcing system-level constraints on generated content.

In yet another example, the customization can be adding and/or updating at least one guardrail and/or restriction (e.g., filter inappropriate content). In this example, the customization can be implemented in the base model to generate a customized model instance by embedding rule-based filtering mechanisms at the token prediction stage and/or applying constraints in the decoding process. In yet another example, the customization can be performing at least one parameter adjustment (e.g., parameters tuned to influence responses without changing the underlying model weights). In this example, the customization can be implemented in the base model to generate a customized model instance by updating top-k or top-p sampling thresholds to refine output stability and/or updating embedding vector scaling factors for token representation adaptation.

In yet another example, the customization can be implementing and/or updating at least one custom template and/or formatting rule. In this example, the customization can be implemented in the base model to generate a customized model instance by injecting structured formatting constraints into the decoding process and/or using predefined prompt patterns to standardize output structures. In yet another example, the customization can be implementing a tool integration (e.g., if the question relates to weather, call the weather API). In this example, the customization can be implemented in the base model to generate a customized model instance by embedding API call triggers into the inference pipeline, updating appending retrieved external data to model-generated responses, and using function-calling to delegate specific tasks to external computational services.

In some implementations, applying the prompt as the input to the model instance to cause the model instance to generate the output is further based at least on the processing circuits identifying at least one tool for execution based on the prompt. That is, the processing circuits can integrate and/or otherwise perform tool integration to facilitate interfacing with external tools to enrich the output and/or offload tool-specific operations. That is, the processing circuits can receive the prompt and identify a required tool, service, and/or data source to supplement the response based on predefined logic and/or model inference. For example, the processing circuits can analyze the prompt for trigger keywords associated with tool execution, such as ‘weather,’ ‘stock price,’ or ‘translation,’ and map the request to an external service. In another example, the processing circuits can retrieve tool-specific execution parameters stored in a configuration database and determine the API call and/or function invocation for obtaining supplemental data.

In some implementations, once the prompt is identified as using external data augmentation, the processing circuits can provide, via at least one interface of the at least one tool, the prompt. The interface of the tool can include a REST API endpoint, a WebSocket connection, an SDK-based integration, and/or a database query system. For example, the processing circuits can send a structured API request with the parameters to the identified tool, receive the response, and incorporate the retrieved data into the model-generated output. Additionally, the processing circuits can receive, via the at least one interface, data corresponding with an execution of the at least one tool. That is, the processing circuits can parse the response from the external tool, extract relevant information, and format the output according to the prompt requirements. For example, the processing circuits can receive structured JSON data from a financial API containing real-time stock market trends and use the extracted values to generate a response contextualized for the query user (e.g., prompt).

In some implementations, the output generated by the model instance comprises the data provided by the at least one tool. For example, an output can be “The current weather in New York City is sunny and 78 degrees Fahrenheit. You can visit Central Park with shorts and a t-shirt.” In this example, a weather forecasting API (e.g., tool) can be interfaced with by the processing circuits to obtain an output that can be merged with the natural language generation of the model to output a user-friendly response. In another example, an output can be “The stock price of Company X as of 2:30 PM EST is $150.34, up 2.1% from the previous close.” In this example, a financial market data provider (e.g., tool) can be interfaced with by the processing circuits to obtain an output that can be incorporated into the generated response of the model.

The method 200, at block 240, includes providing, via the interface, the output for presentation and/or any downstream processing operation associated with the output. That is, the processing circuits can transmit the output to another computational system, store the output in a data repository, and/or enqueue the output for asynchronous processing. For example, the output can be provided to a client device, a data pipeline for further refinement, a storage system for archival, and/or a messaging queue for event-driven workflows. Additionally, providing can include the processing circuits logging the output for auditability, encoding the output in a specific format for interoperability, and/or routing the output based on predefined system policies. For example, the processing circuits can persist the output in a vector database and/or package the output with additional metadata for downstream consumption.

The method 200, at block 250, includes determining a performance metric based on applying an evaluation function to the first output generated by the model instance and a second output generated by a base AI model. That is, the model instance can be evaluated against a base instance of the model. In some implementations, the processing circuits can apply the prompt as input to the base AI model to generate a second output (e.g., without the customizations). That is, the processing circuits can apply the same prompt to the base AI model to evaluate the performance of the customized model instance. Additionally, the processing circuits can determine a performance metric (e.g., quantitative measure to evaluate the effectiveness of prompt tuning applied to the customized model instance) based on applying an evaluation function to the output generated by the model instance and the second output generated by the base AI model. That is, the evaluation function can be a similarity metric (e.g., cosine similarity), distance metric (e.g., Euclidean distance), error rate, and/or scoring function.

In some implementations, applying the evaluation function can include determining a similarity (e.g., e.g., lexical similarity, semantic similarity, syntactic similarity, probability-based similarity, embedding distance, and/or task-specific similarity) between the first output generated by the model instance and the second output generated by the base AI model using at least one of a statistical comparison function, a distance metric, or a probabilistic scoring model. For example, the processing circuits can use a cosine similarity function, token-level edit distance, and/or log-likelihood comparison of token distributions.

The method 200, at block 260, includes updating (e.g., train) the model instance based on the performance metric. That is, the model instance can be trained by updating the at least one parameter of the model instance based on the performance metric. For example, the updating can include performing an update of at least one of: (i) a prompt tuning configuration (e.g., modifying stored prompt representations to refine response generation); (ii) a weighting factor applied to at least one generated token probability (e.g., updating probability distributions to influence token selection); (iii) a constraint on response length (e.g., applying length control mechanisms to modify output verbosity); (iv) a task-specific embedding update (e.g., updating model embeddings to refine domain relevance); (v) a fine-tuning parameter corresponding to decoding (e.g., updating decoding constraints to influence output generation patterns).

In some implementations, the processing circuits can deploy, to the data source, a new model instance by updating the at least one parameter of the base AI model based on a performance metric and updating at least one prompt tuning configuration. That is, the processing circuits can deploy a new, customized version of the base AI model. For example, the deployment of the new model instance can include assigning the identifier or a new identifier to the new model instance. In this example, the processing circuits can store the new model instance in the data source with version metadata, update model routing configurations to allow client access to the latest deployment, and/or apply security and/or access controls to manage multi-user availability.

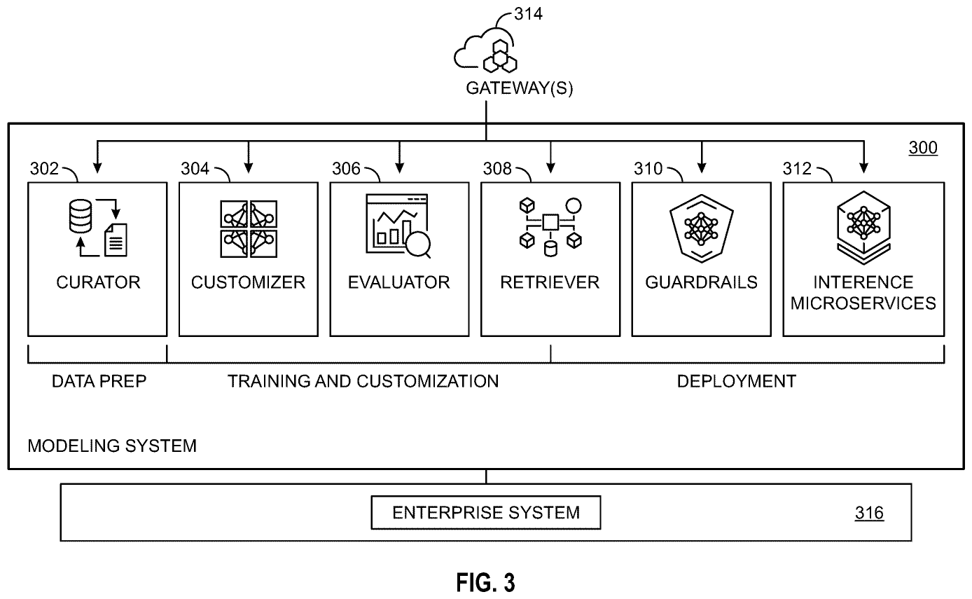

Referring now to FIG. 3, an example model architecture, in accordance with some implementations of the present disclosure. The modeling system 300 (including the same and/or similar features of modeling system 108 of FIG. 1) can include various components configured to facilitate data preparation, training, customization, and deployment of artificial intelligence (AI) models (e.g., model(s) 110 of FIG. 1). The components can be used in conjunction to create, evaluate, and/or deploy prompt-tuned models as distinct instance and/or entities within an enterprise infrastructure. The modeling system 300 can interface with a gateway 314 to communicate with external systems and clients, as well as with an enterprise system 316 to integrate AI models into organizational workflows. The modeling system 300 includes a curator 302, a customizer 304, an evaluator 306, a retriever 308, guardrails 310, and/or inference microservices 312.

In some implementations, the curator 302 can be configured to handle data preparation tasks, such as organizing and preprocessing datasets. In some implementations, the customizer 304 can facilitate the application of model-specific customizations, including prompt tuning and parameter updates. In some implementations, the evaluator 306 can execute performance assessments using evaluation metrics to validate customized models. In some implementations, the retriever 308 can support retrieval-augmented generation (RAG) by accessing external knowledge sources during inference. In some implementations, the guardrails 310 can enforce operational constraints, such as content filtering and ethical guidelines. In some implementations, the inference microservices 312 can manage the execution of customized models to generate outputs for end-user applications. That is, the various components collectively provide server-side model tuning, evaluation, and/or deployment while addressing the technical challenges of traditional client-side operations and/or prompt-tuning.

### Example Language Models

In at least some implementations, language models, such as large language models (LLMs), vision language models (VLMs), small language models (SLMs), multi-modal language models (MMLMs), and/or other types of generative artificial intelligence (AI) can be implemented. Generally, the language models can process input data (e.g., prompts and identifiers) to perform modeling on prompt-tuned model instances and generate performance metrics. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/VLMs/SLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/SLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/SLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/SLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/SLMs/MMLMs/etc. can also include one or more diffusion block(s) (e.g., denoisers). The LLMs/VLMs/SLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/SLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/SLMs/MMLMs/etc. can be trained using unsupervised learning, in which an LLMs/VLMs/SLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/SLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/SLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/SLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/SLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/SLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 4A is a block diagram of an example generative language model system 400 suitable for use in implementing at least some implementations of the present disclosure. Generally, the example generative language model system 400 can process prompts using prompt-tuned model instances and base AI models. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which can include an LLM, a VLM, a multi-modal LM, etc.).

At a high level, the input processor 405 can receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/VLM/MMLM/etc.). In some implementations, the input 401 includes plain text in the form of one or more sentences, paragraphs, and/or documents. Additionally or alternatively, the input 401 can include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 can combine text (or can omit text) with image data, audio data, video data, design data, USD data, and/or other types of input data, such as but not limited to those described herein. Taking raw input text as an example, the input processor 405 can prepare raw input text in various ways. For example, the input processor 405 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 can remove stopwords to reduce noise and focus the generative LM 430 on more meaningful content. The input processor 405 can apply text normalization, for example, by converting all characters to lowercase, removing accents, and/or or handling special cases like contractions or abbreviations to ensure consistency. These are just a few examples, and other types of input processing can be applied.

In some implementations, a RAG component 492 (which can include one or more RAG models, and/or can be performed using the generative LM 430 itself) can be used to retrieve additional information to be used as part of the input 401 or prompt. RAG can be used to enhance the input to the LLM/VLM/MMLM/etc. with external knowledge, so that answers to specific questions or queries or requests are more relevant—such as in a case where specific knowledge is required. The RAG component 492 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 401 can be generated using the query or input to the model (e.g., a question, a request, etc.) in addition to data retrieved using the RAG component 492. In some implementations, the input processor 405 can analyze the input 401 and communicate with the RAG component 492 (or the RAG component 492 can be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 can retrieve a prior stored conversation history—or at least a summary thereof—and include the prior conversation history along with the current ask/request as part of the input 401 to the generative LM 430.

The RAG component 492 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 492 and the embeddings of the chunks along with the embeddings of the query can be compared to identify the most similar/related embeddings to the query, which can be supplied to the generative LM 430 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database.

In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 492 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 410 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy can depend on factors such as the language being processed, the task at hand, and/or characteristics of the training dataset. As such, the tokenizer 410 can convert the (e.g., processed) text into a structured format according to tokenization schema being implemented in the particular implementation.

The embedding component 420 can use any known embedding technique to transform discrete tokens into (e.g., dense, continuous vector) representations of semantic meaning. For example, the embedding component 420 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 405 can resize the data to a standard size compatible with format of a corresponding input channel and/or can normalize pixel values to a common range (e.g., 0 to 1) to ensure a consistent representation, and the embedding component 420 can encode the image data using any known technique (e.g., using one or more convolutional neural networks (CNNs) to extract visual features). In some implementations in which the input 401 includes audio data, the input processor 405 can resample an audio file to a consistent sampling rate for uniform processing, and the embedding component 420 can use any known technique to extract and encode audio features—such as in the form of a spectrogram (e.g., a mel-spectrogram). In some implementations in which the input 401 includes video data, the input processor 405 can extract frames or apply resizing to extracted frames, and the embedding component 420 can extract features such as optical flow embeddings or video embeddings and/or can encode temporal information or sequences of frames. In some implementations in which the input 401 includes multi-modal data, the embedding component 420 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 can apply an encoded representation of the input 401 to the generative LM 430, and the generative LM 430 can process the encoded representation of the input 401 to generate an output 490, which can include responsive text and/or other types of data.

As described herein, in some implementations, the generative LM 430 can be configured to access or use—or capable of accessing or using—plug-ins/APIs 495 (which can include one or more plug-ins, application programming interfaces (APIs), databases, data stores, repositories, etc.). For example, for certain tasks or operations that the generative LM 430 is not ideally suited for, the model can have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 495 to the plug-in/API 495, the plug-in/API 495 can process the information and return an answer to the generative LM 430, and the generative LM 430 can use the response to generate the output 490. This process can be repeated—e.g., recursively—for any number of iterations and using any number of plug-ins/APIs 495 until an output 490 that addresses each ask/question/request/process/operation/etc. from the input 401 can be generated. As such, the model(s) can not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. Generally, the generative LM 430 can process prompts and/or identifiers received via an interface system 106 of FIG. 1 to generate outputs using prompt-tuned models of modeling system 108 of FIG. 1. For example, assume input text such as “Who discovered gravity” is tokenized (e.g., by the tokenizer410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 440 can convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 can generate a first token, and the generation mechanism 455 can apply the generated token as an input during a second pass. The process can repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 can output some decoded (e.g., vector) representation of the input being applied during a particular pass. The classifier 450 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 can select or sample a word or token based on a corresponding predicted probability (e.g., select the word with the highest predicted probability) and append it to the output from a previous pass, generating each word or token sequentially. The generation mechanism 455 can repeat the process, triggering successive decoder inputs and corresponding predictions until selecting or sampling a symbol or token that represents the end of the response, at which point, the generation mechanism 455 can output the generated response.

FIG. 4C is a block diagram of an example implementation in which the generative LM 430 includes a decoder-only transformer architecture. For example, the decoder(s) 460 of FIG. 4C can operate similarly as the decoder(s) 445 of FIG. 4B except each of the decoder(s) 460 of FIG. 4C omits the encoder-decoder self-attention layer (since there is no encoder in this implementation). As such, the decoder(s) 460 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 460. As with the decoder(s) 445 of FIG. 4B, each token (e.g., word) can flow through a separate path in the decoder(s) 460, and the decoder(s) 460, a classifier 465, and a generation mechanism 470 can use auto-regression to sequentially generate one token at a time until predicting a symbol or token that represents the end of the response. The classifier 465 and the generation mechanism 470 can operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 5 is a block diagram of an example computing device(s) 500 suitable for use in implementing some implementations of the present disclosure. Generally, the example computing device(s) 500 can execute operations of the interface system, modeling system, metric system and/or manage data transmission and retrieval of model instances for modeling prompts. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 can comprise one or more virtual machines (VMs), and/or any of the components thereof can comprise virtual components (e.g., virtual hardware components). For non-limiting examples, one or more of the GPUs 508 can comprise one or more vGPUs, one or more of the CPUs 506 can comprise one or more vCPUs, and/or one or more of the logic units 520 can comprise one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In implementations, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In implementations, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 can include one or more data processing units (DPUs) to transmit data received over a network and/or through interconnect system 502 directly to (e.g., a memory of) one or more GPU(s) 508.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one implementations of the present disclosure. Generally, the example data center 600 can provide computational resources, such as processing circuitry, memory, and storage, to support the operations of the system 100 and the execution of model(s) 110 of FIG. 1. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one implementation, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) can correspond to a server having one or more of the above-mentioned computing resources. In addition, in some implementations, the node C.R.s 616(1)-6161(N) can include one or more virtual components, such as vGPUs, vCPUs, and/or the like, and/or one or more of the node C.R.s 616(1)-616(N) can correspond to a virtual machine (VM).

In at least one implementation, grouped computing resources 614 can include separate groupings of node C.R.s 616 housed within one or more racks (not shown), or many racks housed in data centers at various geographical locations (also not shown). Separate groupings of node C.R. s 616 within grouped computing resources 614 can include grouped compute, network, memory or storage resources that can be configured or allocated to support one or more workloads. In at least one implementation, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one implementation, resource orchestrator 612 can include a software design infrastructure (SDI) management entity for the data center 600. The resource orchestrator 612 can include hardware, software, or some combination thereof.

In at least one implementation, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can use distributed file system 638 for large-scale data processing (e.g., “big data”). In at least one implementation, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one implementation, clustered or grouped computing resources can include grouped computing resource 614 at data center infrastructure layer 610. The resource manager 636 can coordinate with resource orchestrator 612 to manage these mapped or allocated computing resources.

In at least one implementation, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one implementation, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 600. In at least one implementation, trained or deployed machine learning models corresponding to one or more neural networks can be used to infer or predict information using resources described above with respect to the data center 600 by using weight parameters calculated through one or more training techniques, such as but not limited to those described herein.

In at least one implementation, the data center 600 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors to execute operations comprising:
receive, via an interface, a prompt and an identifier corresponding to a model instance;
obtain, from a data source using the identifier, the model instance, the model instance comprising at least one customization applied to a base artificial intelligence (AI) model, the at least one customization corresponding to an update to at least one parameter of the base AI model;
apply the prompt as input to the model instance to cause the model instance to generate an output based at least on the at least one customization; and
provide, via the interface, the output for presentation.

2. The system of claim 1, wherein the one or more processors are to execute operations comprising:
apply the prompt as input to the base AI model to generate a second output; and
determine a performance metric based at least on applying an evaluation function to the output generated using the model instance and the second output generated using the base AI model.

3. The system of claim 2, wherein the one or more processors are to execute operations comprising:
deploy, to the data source, a new model instance by updating the at least one parameter of the base AI model based on the performance metric and updating at least one prompt tuning configuration, wherein the deployment of the new model instance comprises assigning the identifier or a new identifier to the new model instance.

4. The system of claim 1, wherein the model instance comprises an AI model based on the base AI model and at least one prompt tuning configuration implementing the at least one customization to the base AI model defined by the at least one parameter, and wherein the model instance and corresponding metadata is stored in the data source, and wherein the corresponding metadata comprises at least the identifier and version information of the model instance.

5. The system of claim 4, wherein the AI model is a prompt-tuned model generated by applying the at least one prompt tuning configuration, wherein the at least one prompt tuning configuration updates modeling operations of the base AI model, wherein prompt-tuning the prompt-tuned model comprises updating at least one token embedding, attention mechanism, or activation function in the base AI model based on the at least one prompt tuning configuration.

6. The system of claim 1, wherein the update to the at least one parameter of the base AI model to generate the model instance comprises updating at least one of (i) a task-specific parameter, (ii) a system parameter, (iii) a guardrail parameter, (iv) a template parameter, (v) a tool integration parameter.

7. The system of claim 1, wherein the applying the prompt as the input to the model instance to cause the model instance to generate the output is further based at least on:
identifying at least one tool for execution based on the prompt;
provide, via at least one interface of the at least one tool, the prompt; and
receive, via the at least one interface, data corresponding with an execution of the at least one tool;
wherein the output generated by the model instance comprises the data provided by the at least one tool.

8. The system of claim 1, wherein the one or more processors are to execute operations comprising:
update the prompt based at least on at least one prompt configuration corresponding with the model instance, wherein the updated prompt is applied as the input to the model instance.

9. The system of claim 1, wherein the model instance is obtained from the data source and configured for multi-client access in a client-server architecture, wherein the one or more processors are to execute operations comprising:
receive, via the interface, a second prompt and the identifier corresponding to the model instance;
apply the prompt as input to the model instance to cause the model instance to generate a second output based at least on the at least one customization; and
provide, via the interface, the second output.

10. The system of claim 1, wherein the one or more processors are to execute operations comprising:
a system for implementing customized models;
a system for applying configurations to one or more models;
a system for performing simulation operations;
a system for performing real-time streaming;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a control system for an autonomous or semi-autonomous machine;
a perception system for an autonomous or semi-autonomous machine;
a system for performing digital twin operations;
a system for performing light transport simulation;
a system for performing remote operations;
a system implemented using an edge device;
a system implemented using a robot;
a system for performing conversational AI operations;
a system incorporating one or more virtual machines (VMs);
a system implemented at least partially in a data center; or
a system implemented at least partially using cloud computing resources.

11. One or more processors comprising processing circuitry to:
receive, via an interface, a prompt and an identifier corresponding to a model instance;
obtain, from a data source using the identifier, the model instance comprising at least one customization applied to a base artificial intelligence (AI) model, the at least one customization corresponding to an update to at least one parameter of the base AI model;
apply the prompt as input to the model instance to cause the model instance to generate a first output based at least on the at least one customization;
apply the prompt as input to the base AI model to generate a second output;
determine a performance metric based on applying an evaluation function to the first output generated using the model instance and the second output generated using the base AI model; and
update the model instance based at least on the performance metric.

12. The one or more processors of claim 11, wherein the applying the evaluation function comprises determining a similarity between the first output generated using the model instance and the second output generated using the base AI model using at least one of a statistical comparison function, a distance metric, or a probabilistic scoring model.

13. The one or more processors of claim 11, wherein the updating the model instance comprises updating the at least one parameter of the model instance based on the performance metric by:
updating at least one of (i) a prompt tuning configuration, (ii) a weighting factor applied to at least one generated token probabilities, (iii) a constraint on response length, (iv) a task-specific embedding update, or (v) a fine-tuning parameter corresponding to decoding; and
storing the updated model instance in the data source with versioning metadata.

14. The one or more processors of claim 11, wherein the model instance comprises an AI model based on the base AI model and at least one prompt tuning configuration implementing the at least one customization to the base AI model defined using the at least one parameter, and wherein the model instance and corresponding metadata is stored in the data source, and wherein the corresponding metadata comprises at least the identifier and version information of the model instance.

15. The one or more processors of claim 14, wherein the AI model is a prompt-tuned model generated by applying the at least one prompt tuning configuration, wherein the at least one prompt tuning configuration updates modeling operations of the base AI model, wherein prompt-tuning the prompt-tuned model comprises updating at least one token embedding, attention mechanism, or activation function in the base AI model based on the at least one prompt tuning configuration.

16. The one or more processors of claim 11, wherein the model instance is obtained from the data source and configured for multi-client access in a client-server architecture.

17. A method, comprising:
receiving, via an interface, a prompt comprising an identifier corresponding to a model instance;
obtaining, from a data source using the identifier, the model instance, the model instance comprising at least one customization applied to a base artificial intelligence (AI) model, the at least one customization corresponding to an update to at least one parameter of the base AI model;
generate, using the model instance, an output based at least on the prompt and the at least one customization; and
providing, via the interface, the output.

18. The method of claim 17, further comprising:
applying the prompt as input to the base AI model to generate a second output; and
determining a performance metric based on applying an evaluation function to the output generated using the model instance and the second output generated using the base AI model.

19. The method of claim 18, further comprising:
deploying, to the data source, a new model instance by updating the at least one parameter of the base AI model based on the performance metric and updating at least one prompt tuning configuration, wherein the deployment of the new model instance comprises assigning the identifier or a new identifier to the new model instance.

20. The method of claim 17, wherein the model instance comprises an AI model based on the base AI model and at least one prompt tuning configuration implementing the at least one customization to the base AI model defined by the at least one parameter, and wherein the model instance and corresponding metadata is stored in the data source, and wherein the corresponding metadata comprises at least the identifier and version information of the model instance.
